(19) United States
(12) Patent Application Publication
(10) Pub. No.: US 2017/0291626 A1
(43) Pub. Date: Oct. 12, 2017

(54) WEIGHT ACTIVATED WHEEL BRAKE APPARATUS AND SYSTEM

(71) Applicant: Van Lewellyn Albert, Chestertown, MD (US)

(72) Inventor: Van Lewellyn Albert, Chestertown, MD (US)

(21) Appl. No.: 15/481,735

(22) Filed: Apr. 7, 2017

Related U.S. Application Data
(60) Provisional application No. 62/319,937, filed on Apr. 8, 2016.

(51) Int. Cl. B62B 5/04; B62B 5/02

(52) U.S. Cl. CPC B62B 5/04; B62B 5/02; A61G 5/061

(57) ABSTRACT

An apparatus and system for facilitating the controlled ascent and descent of stepped or irregular inclines, such as a set or flight of stairs. In an embodiment, the invention comprises an apparatus and system that allows an operator to safely transport a heavy load up or down a flight of stairs. The invention may be utilized with, attached to or incorporated within a transporting carrier, such as a hand truck or hand cart, for transporting heavy cargo up or down stepped or irregular inclines. In an embodiment, the invention allows a wheel to rotate freely in one direction while regulating the rotation of said wheel in the opposite direction such that a braking force in said opposite direction is proportional to the apparent weight and angle of inclination of said carrier. In operation, a gravitationally induced increase in an apparent weight activates the invention's braking system, thereby providing a braking force to the carrier wheel.

### PRIORITY

This application is the Non-Provisional application of Provisional Application No. 62/319,937 (Confirmation No. 7951), filed on Apr. 8, 2016 for “System and Apparatus for the Controlled Ascent and Descent of Stepped and Irregular Inclines with Wheeled Carriers” by Van L. Albert. This Non-Provisional application claims priority to and the benefit of that Provisional application, the contents and subject of which are incorporated herein by reference in their entirety.

### SUMMARY OF THE INVENTION

The present invention relates generally to an apparatus and system for facilitating the controlled ascent and descent of stepped or irregular inclines, such as a set or flight of stairs. In an embodiment, the invention comprises an apparatus and system that allows an operator to safely transport a heavy load up or down a flight of stairs. The invention may be utilized with, attached to or incorporated within a transporting carrier, such as a hand truck or hand cart for transporting heavy cargo. In an embodiment, the invention allows a wheel to rotate freely in one direction while regulating the rotation of said wheel in the opposite direction such that a braking force in said opposite direction is proportional to the apparent weight and angle of inclination of said carrier. In operation, a gravitationally induced increase in an apparent weight activates the invention's braking system, thereby providing a braking force to the carrier wheel.

### BACKGROUND

Despite recent innovative technologies and the development of lightweight, versatile handcarts, transporting heavy or unwieldy objects up and down steps or a flight of stairs remains a challenge. Motorized or mechanical stair-climbing devices have proven to be of limited usefulness, either due to cost, extra weight, or to bulky mechanisms that restrict the capacity or dimensions of the load being transported.

A set of stairs typically comprises a plurality of step-riser sets that allow a user to ascend or descend from various height levels, such as floors or stories, within a building structure. A cross-sectional view of a set of a typical set of stairs is depicted in FIG. 1A. Generally, and often dependent on the amount of space available, stairs are defined by two primary geometric components: rise and run. Rise is generally defined as the total vertical height of a given a set of stairs, for example, from the ground or base floor F to the highest level of the stairs, which is typically a destination floor. In an average home, for instance, the rise of a set of stairs from the ground floor F to the second level may be in the range of 8-10 feet. Referring to FIG. 1A, the rise is defined by the change in the Y value from the point of origin O on ground floor F to the destination floor. The run is the horizontal length of the stairs required to provide a generally safe rise. Referring to FIG. 1A, the run is defined by the change in the X value along the ground floor F.

Stair angles are generally in the range of from about 30 degrees to 37 degrees. Stairs with an angle of 90 degrees are essentially a vertical ladder perpendicular to a level floor, with the floor being at a relative angle of zero degrees (0°). The angle is based on the amount of space available, but is commonly determined by the rise and run of a stair. For example, using a common set of stairs employing 7 inch risers and 11 inch treads (typically a minimum amount), the angle of the stairs is 32 degrees (calculated by the arctan( 7/11)).

Many of the issues encountered when attempting to transport heavy objects up or down stairs could be easily resolved for the ascent portion of a stepped incline simply by employing a carrier apparatus whose wheels have a radius that equals or exceeds the height of the stair risers being traversed. In such a case, the wheel's axis, being located above the plane of the stair riser being ascended, would enable the carrier and its load to simply roll up the stairs with relative ease. Moreover, larger wheels have the advantage during ascent that the X-Y directional vector of such a larger wheel's axis describes a repeating curve with a gentle, regular slope, much like the vector of human subjects during the ascent of a stepped incline. Thus, using a carrier with wheels whose radius exceeds the height of the stair riser provides a simple solution to the transport of loads up stepped inclines in a manner which, in contrast to the sharply angular vector described by carriers with smaller wheels and allows the transport of larger loads with less energy expenditure.

However, the same properties that make a transport device with larger wheels effective for ascending stepped inclines make them impracticable and dangerous for descending them. The absence of appreciable friction in wheel systems and an uninterrupted, roughly 32 degree downward vector transforms the large-wheeled carrier apparatus into a largely uncontrollable object whose momentum and velocity increase exponentially in both horizontal and vertical direction as soon as the centerline of the wheel crosses the edge of the stair riser. Even for persons with the physical strength and the mental acuity to negotiate a large-wheeled carrier down stairs or a stepped incline, the likelihood is high that a miscalculation or misstep would result in a catastrophic event with damaging and injurious consequences.

For these reasons, light- to medium-duty handcart wheels have historically been limited to a diameter that is roughly equal to or smaller than the standard 7¾ inch stair riser. Heavier-duty handcarts and carriers are commercially available that employ wheel sets with a diameter of eight inches, which corresponds to about 70% of the minimum acceptable stair tread depth of 11 inches. With this wheel size, the entire wheel profile falls within the footprint of the stair tread, which provides the operator with enough surface area on each stair tread to maneuver the carrier to a steady resting position and prepare for ascent or descent to the next higher stair level, facilitating a controlled albeit physically demanding and time-consuming descent.

However, the angular vector that enables a controlled descent also results in a greater effort during ascent. See FIG. 1B. The carrier and its load must be effectively lifted parallel to the force of gravity in order to ascend each stair rise. Moreover, if the stair is outfitted with a nosing or has open risers with no vertical backplate, the small wheel becomes wedged between the horizontal edge of the next stair and the floor of the current stair, which requires additional energy expenditure to maneuver the wheel's axis over the nosing or over the edge of a step tread with no vertical backplate below to the tread of the next higher step tread. Although the aforementioned disadvantages of small wheels would be redressed for the ascent of stairs by larger wheels, the potential hazards of the descent of stairs using carriers with larger wheels have historically made their implementation commercially impracticable.

Some attempts have been made to outfit handcarts or other non-motorized carriers with hand-operated brakes to assist in the controlled ascent and descent of stairs. However, a hand-operated brake depends on a human subject to regulate the application of the braking force, and due to the aforementioned complexity of the physical forces involved in the descent of larger-wheeled carriers down stepped inclines, human application of the braking force is prone to error which may lead to loss of control of both the brake mechanism and the carrier with potentially disastrous and injurious consequences. Moreover, guiding a hand-operated carrier with a significant load down a stepped incline is a physically strenuous effort that requires two hands. Requiring one of those hands to also engage a braking mechanism requires a higher level of dexterity and coordination and increases the likelihood of a catastrophic error. Thus, handcarts with braking mechanisms are generally only available on extremely heavy-duty equipment that are designed to transport extremely heavy or bulky loads and be operated by more than one person at a time.

Some commercially available hand-trucks are outfitted with glide rails, which are rails affixed to the frame of the carrier behind the wheels roughly parallel to the vertical component of the frame. Such glide rails are designed to change the vector of ascent from angular to sloped in order to guide the carrier across the edge of the tread and any offset nosing. Glide rails have the disadvantages that they add friction to the system, thus considerably increasing the effective weight of the load, and can potentially damage carpets, any finish on the stairs, or even damage the stair surface itself. Moreover, like large wheels, glide rails are subject to gravitational and angular forces that cause the load to accelerate downward exponentially during descent. Thus glide rails, while useful during ascent, are of limited usefulness for descending flights of stairs with a large load. Glide rails are most effective during the stair ascent and are often used in activities such as moving or delivery, whereby the load is only transported one way up the stairs and the carrier is carried manually down the stairs after the delivery items have been offloaded.

Hand-operated stair-climbing carriers are commercially available whose stair-climbing facility comprises two parallel arrays of three wheels, each of which is mounted to one end of an axle. However, each wheel array requires a solid frame on which to mount the individual wheels, adding to weight of the carrier. Moreover, while such carriers might aid in the ascent of stairs in comparison to carriers with smaller single wheels, on descent they are subject to the same gravity-driven horizontal and vertical acceleration as carriers with single wheels and thus are subject to the same limitations and hazards as single-wheeled carriers.

While some carriers, specifically wheelchairs, have been outfitted with mechanisms that allow forward wheel rotation while preventing or restricting rearward wheel rotation in order to prevent or impede undesirable rearward rolling on an incline, such devices have no utility on stepped inclines because the mechanism that limits rearward rotation is ultimately regulated by an occupant-activated brake mechanism. Thus, in order to descend an irregular or stepped incline, the occupant must possess the physical strength and mental acuity to apply a sufficient braking force to effectively counter the gravity-driven horizontal and vertical momentum resulting from the occupant's weight as well as the complex rotational, angular and gravitational forces involved in the wheeled descent of stepped or irregular inclines. Such mechanisms, while useful on wheelchairs on regular inclines with a slope angle of less than roughly 30 degrees from horizontal, are not useful on hand-operated hand trucks or other wheeled carriers for traversing stepped or irregular inclines.

In consideration of the aforementioned background, the current invention fills a longstanding need for a self-regulating brake mechanism for hand-operated wheeled carriers that allows the carrier's wheels to free-wheel in the forward direction while applying a braking force in the rearward direction, whereby said braking force is proportional to the apparent weight of the carrier and serves to both prevent rollback during ascent and to reduce or neutralize the rotational, angular and gravitational forces that propel the carrier downward during transition from one stair level to another during descent.

### BRIEF DESCRIPTION OF THE DRAWINGS

Referring now to the attached drawings which form a part of this original disclosure:

FIG. 1A is a cross sectional, two-dimensional perspective view of a common set of stairs for illustrative purposes (not an embodiment of the invention).

FIG. 1B is the illustration of a common set of stairs of FIG. 1A depicting the relative motion of a wheel transcending the stairs (for illustrative purposes and not an embodiment of the invention).

FIG. 2 is a perspective view of an embodiment of the invention, with a spoked wheel-tire assembly, attached to the undercarriage of a handcart.

FIG. 3 is a perspective view of an embodiment of the invention fully assembled and depicting a suspension assembly, braking hub assembly, freewheel assembly hub and spindle.

FIG. 4 is an exploded view of the general embodiment of the invention depicted in FIG. 3.

FIG. 5 is an exploded view of the suspension assembly portion of an embodiment of the invention.

FIG. 5A is a perspective view of a portion of an unassembled suspension assembly of an embodiment of the invention.

FIG. 5B is a perspective view of a portion the suspension assembly of an embodiment of the invention.

FIG. 5C is an enlarged perspective view of a portion the suspension assembly of an embodiment of the invention.

FIG. 6A is a perspective view of the braking hub assembly of an embodiment of the invention.

FIG. 6B is an additional perspective view of the braking hub assembly of an embodiment of the invention.

FIG. 7A-7C are perspective views of the spindle portion.

FIG. 8A is a perspective view of the freewheel hub assembly of an embodiment of the invention.

FIG. 8B is an additional perspective view of the freewheel hub assembly of an embodiment of the invention

FIG. 9 is a perspective view of a fully assembled embodiment of the invention attached to an undercarriage.

FIG. 10A is a perspective side view of an embodiment attached to a carrier with a weight applied thereto and depicting a portion of the tire of the wheel assembly in contact with the ground.

FIG. 10B is a perspective side view of the embodiment of FIG. 9A attached to a carrier with a second weight applied thereto and depicting a portion of the tire of the wheel assembly in contact with the ground.

FIG. 10C is a perspective side view of the embodiment of FIG. 9A attached to a carrier with a third weight applied thereto and depicting a portion of the tire of the wheel assembly in contact with the ground.

FIGS. 11A-11E depict a series of side views of a carrier with an embodiment of the invention attached thereto transporting a weighted cargo on an illustrative set of stairs by descending a stair step thereon.

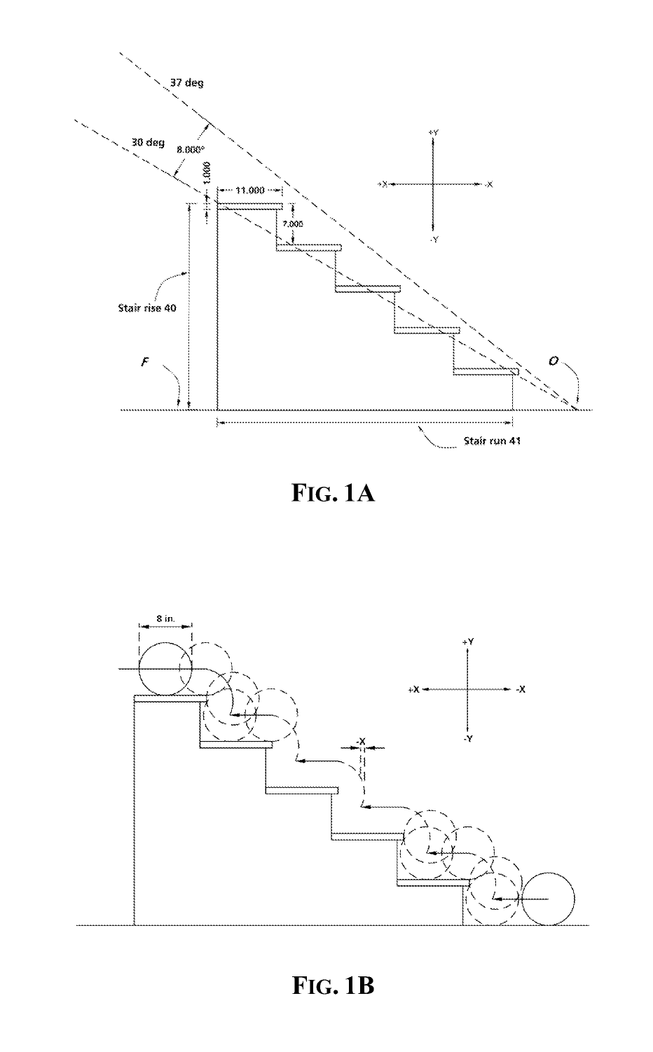

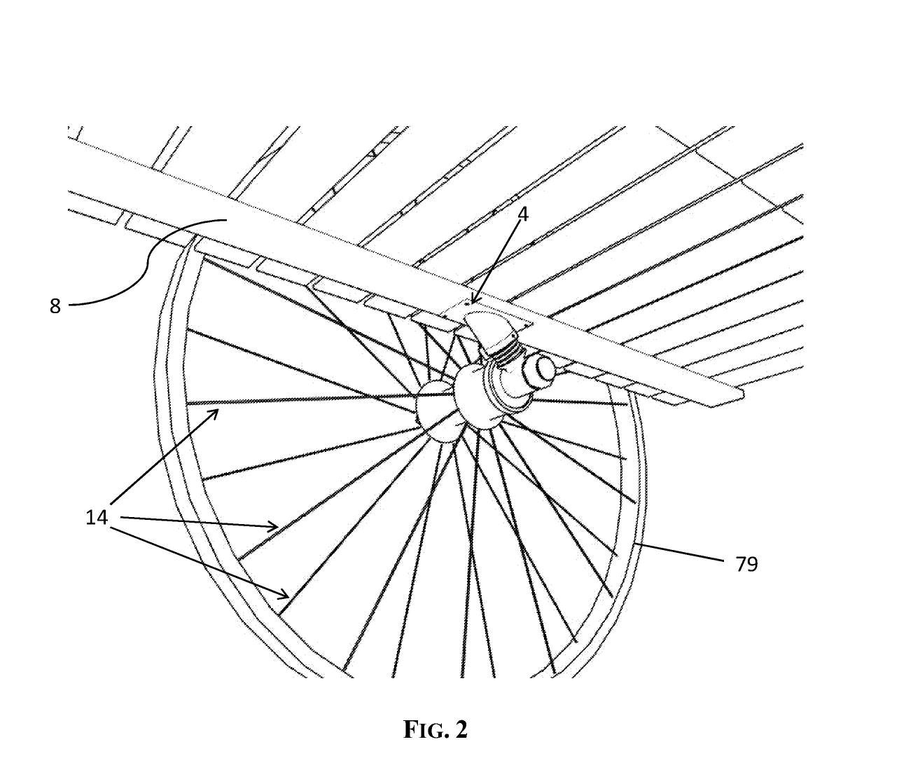

### FIGURE REFERENCES

Physical embodiments of the invention comprise various device elements, features, portions and assemblies, singly or in combination, and are depicted in the attached drawings. The following is a listing of the reference numbers and the associated elements and features of the devices as shown in the attached illustrations:
100 Suspension Assembly
2 Suspension body portion (comprising a tubular-shaped main suspension body, with an internal volume (further comprising an internal cylindrical piston bore 33) and an external surface 2A)
2A External surface of main suspension body
28 Alignment rod
29 Recessed spring retainer pan
30 Spring retainer fitting (for securing coil suspension spring 6 to suspension body 2)
33 Internal cylindrical piston bore of suspension body 2 (for receipt of suspension arm piston 32)
69 Inner perimeter wall of spring retainer pan
70 Outer perimeter wall of retainer pan
3 Suspension Arm
24 Female alignment fitting (for receipt of support flange male fitting 23 of spindle 9)
25 Mounting aperture (for receipt and non-rotatable attachment of spindle mounting stub 18 comprising the first end of spindle 9)
32 Suspension arm piston (for insertion into piston bore 33 and further comprising an internal piston alignment bore 66 for receipt of alignment rod 28)
60 Mounting arm element
62 Suspension arm spring/piston mount
63 Recessed spring/piston mount pan
64 Suspension arm spring/piston mount outer perimeter wall
65 Suspension arm spring retainer fitting (for securing coil suspension spring 6 to suspension arm 3)
66 Internal piston alignment bore for secure receipt and alignment of alignment rod 28
6 Coil suspension spring
7 Brake actuator
31 Brake actuator mount
35 Brake actuator calibration spring
67 Calibration spring mounting block
68 Brake pad
4 Mounting plate
5 Coil spring orientation angle
200 Braking Hub Assembly
10 Brake hub
11 Brake band
17 Braking hub ratchet pawls
20 Braking hub body
20A Exterior portion or surface of braking hub body
20B Internal portion of braking hub body (further comprising a ball bearing BB holding flange, not numbered)
72 Spindle aperture within internal portion 20B of braking hub body 20 (further comprising a ball bearing BB holding flange, not numbered)
74 Outer rim portion of brake hub 10
76 Internal flange rim of brake hub 10
300 Freewheel Hub Assembly
12 Freewheel hub
12A Freewheel hub extension
12B Internal portion of freewheel hub extension (further comprising a ball bearing BB holding flange, not numbered)
13 Hub flanges
14 Wheel spokes
15 Ratchet extension hub
15A Outer body portion of ratchet extension hub 15
15B Internal portion of ratchet extension hub 15 (further comprising a ball bearing BB holding flange, not numbered)
16 Ratchet teeth
80 Spindle portion comprising spindle (9) and related spindle attachment elements and securing elements, features and hardware
9 Spindle
18 Spindle mounting stub
18A Threaded end of mounting stub (comprising first end of spindle 9)
19 Spindle rod
19A Spindle rod terminus (comprising second end of spindle 9)
21 Support flange
21A Flat surface side to support flange 21 (first side to support flange 22)
22 Support flange bearing cone (second side to support flange 22)
23 Male support flange element (for securing in corresponding female alignment fitting 24 in suspension arm 3)
26 Tabbed washers
27 Dust cover
77 Mounting nuts
78 Spindle rod groove/slot
79 Wheel-rim-tire
81 Coned nuts (for use with ball bearings BB)
82 Flat washers
BB Ball bearings (various sizes or gauges)

### MISCELLANEOUS REFERENCE NUMBERS

8 Carrier structure
36 Carrier gross weight
37 Carrier weight
38 Load weight
39 Contact surface
40 Stair rise
41 Stair run
42 Supporting surface
43 Wheel overhang
44 Carrier handle
45 Tangent angle
83 Stair tread
84 Carrier frame

The within description and illustrations of various embodiments of the invention are neither intended nor should be construed as being representative of the full extent and scope of the present invention. While particular embodiments of the invention are illustrated and described, singly and in combination, it will be apparent that various modifications and combinations of the invention detailed in the text and drawings can be made without departing from the spirit and scope of the invention. For example, references to materials of construction, methods of construction, specific dimensions, shapes, utilities or applications are also not intended to be limiting in any manner and other materials and dimensions could be substituted and remain within the spirit and scope of the invention. Accordingly, it is not intended that the invention be limited in any fashion. Rather, particular, detailed and exemplary embodiments are presented.

The images in the drawings are simplified for illustrative purposes and are not necessarily depicted to scale, although effort has been made to do so. To facilitate understanding, identical reference numerals are used, where possible, to designate substantially identical elements that are common to the figures, except that suffixes may be added, when appropriate, to differentiate such elements.

Although the invention herein has been described with reference to particular illustrative and exemplary physical embodiments thereof, as well as a methodology thereof, it is to be understood that the disclosed embodiments are merely illustrative of the principles and applications of the present invention. Therefore, numerous modifications may be made to the illustrative embodiments and other arrangements may be devised without departing from the spirit and scope of the present invention. It has been contemplated that features or steps of one embodiment may be incorporated in other embodiments of the invention without further recitation.

### DETAILED DESCRIPTION OF EMBODIMENTS

Selected embodiments will now be explained with reference to the drawings. It will be apparent to those skilled in the art that the following descriptions of the embodiments are provided for illustration only and not for the purpose of limiting the invention as defined by the claims.

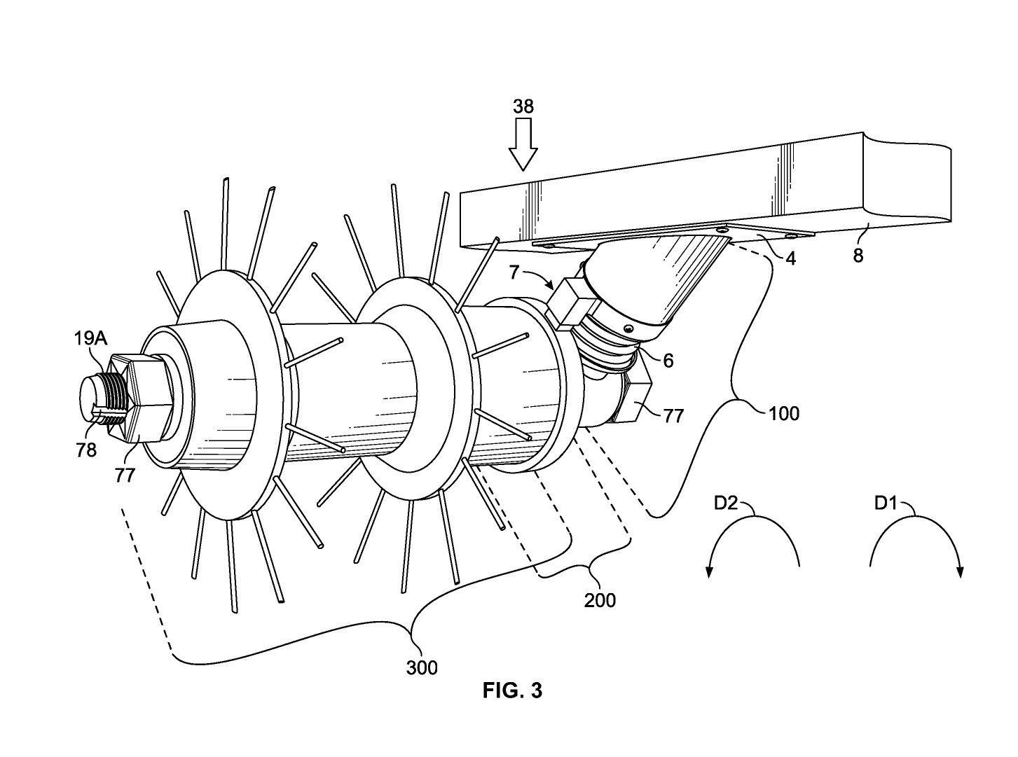

Referring initially to FIG. 3, an embodiment of the invention is depicted attached to the undercarriage of a carrying device, such as, but not limited to, a hand cart or other device that may be used for manually transporting heavy loads, particularly for transcending and descending a plurality of steps or a set of stairs. The embodiment of FIG. 3 is directed for use with a single wheel. The two sets of spokes depicted in that illustration are the corresponding spokes on each side of a wheel that may be further comprised of a rim and tire (occasionally referred to herein as a “spoked-wheel-tire assembly”). In practice, however, the embodiment of FIG. 3 would be duplicated and the two devices/systems would generally be applied or used in connection with both wheels of at two wheeled cart to provide for a dual braking system. That is, the invention may be specifically incorporated for use with both wheels of a two wheeled hand cart—each embodiment attached to each side of the undercarriage of the cart—whereby the intended braking action may be applied independently to each of the two wheels of the cart. While two separate devices/systems of an embodiment of the invention may be used in this manner, the within description will address the invention without reference to a dual system for convenience. The description, therefore, may, depending on the illustration under discussion, be directed towards an embodiment that is oriented towards a wheel on a particular side—or the corresponding wheel on the opposite side—of a hand cart, but the description is meant to be interchangeable and apply to the embodiment being discussed regardless of which side of the cart it is incorporated for use. It is therefore understood that in such cases that embodiments for one wheel side or the other wheel side are identical except as to orientation and may represent isomers or mirror images of each other.

Referring to FIG. 3, an embodiment of the invention is generally comprised of a suspension assembly 100, a braking hub assembly 200, a freewheel hub assembly 300 and a spindle portion (with related attachment means and hardware) 80, wherein the spindle portion (with related attachment means and hardware) 80 provides the central means of securing or attaching the various assemblies with each other for interaction and integrating the physical forces necessary to provide sufficient weight activated braking of the corresponding wheel. As demonstrated herein, the wheel is also depicted as spoked-wheel-tire assembly and an element of various embodiments, which is attached and secured to the embodiment assemblies by the spindle portion. While depicted as such, it is understood that wheels come in many forms, such as, for example, without spokes, and that the specific spoked-wheel-tire assembly depicted in the embodiments is not a limiting feature of the invention. The various assembly portions of an embodiment are first discussed individually.

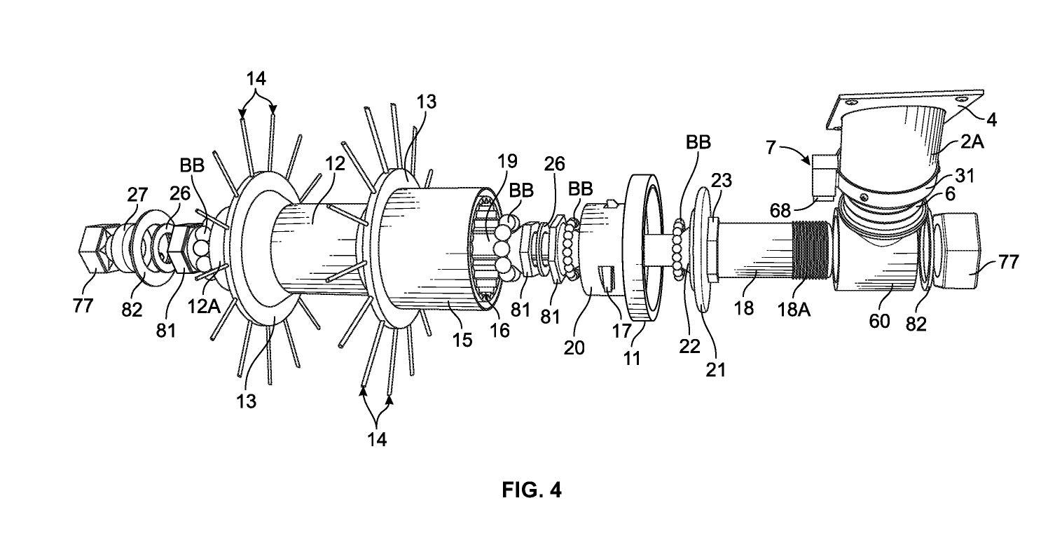

FIG. 4 is an exploded view of the embodiment of FIG. 3, further depicting various hardware elements and features that may be used to secure and assemble the suspension assembly 100, the braking hub assembly 200 and the freewheel hub assembly 300 to and about the spindle portion into an assemble embodiment. When discussing the various drawings hereafter, reference should be made to FIGS. 3 and 4 for additional context and support.

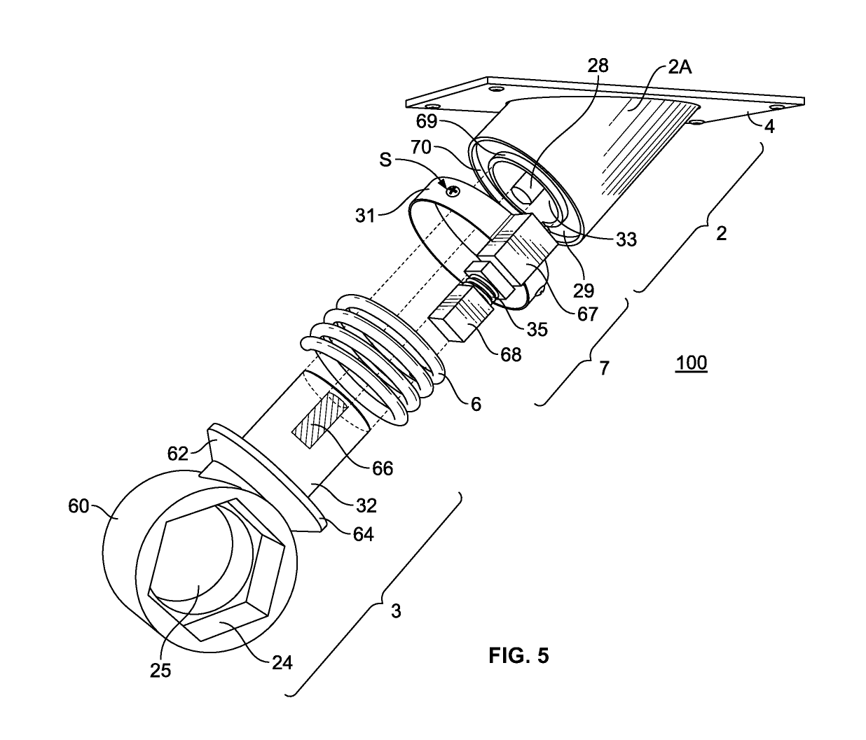

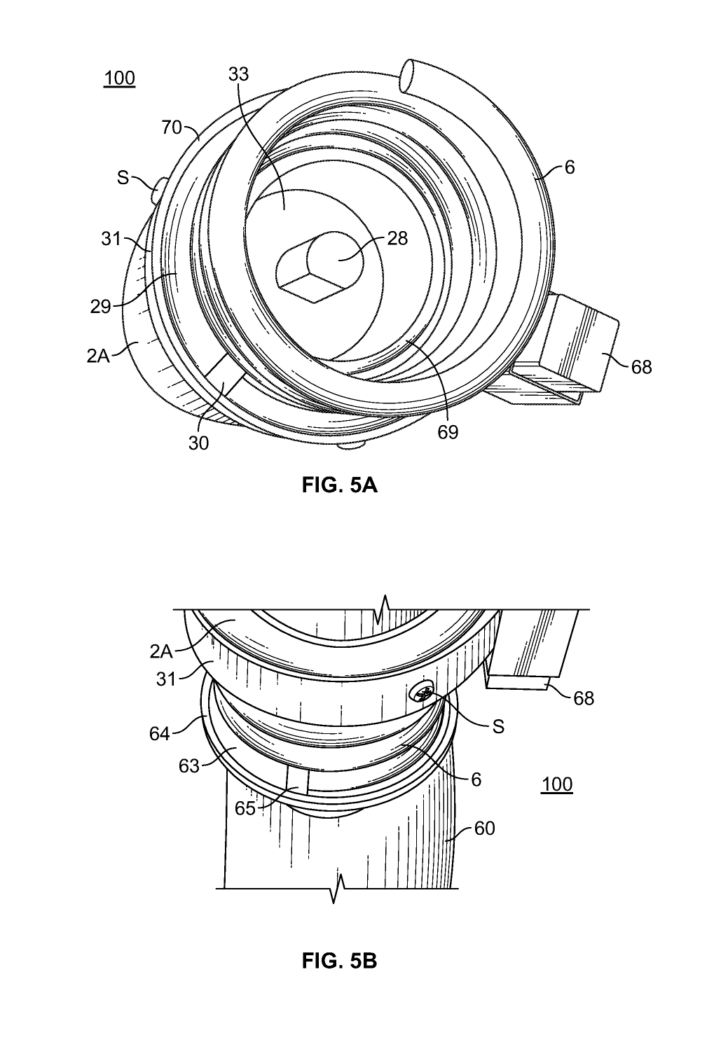

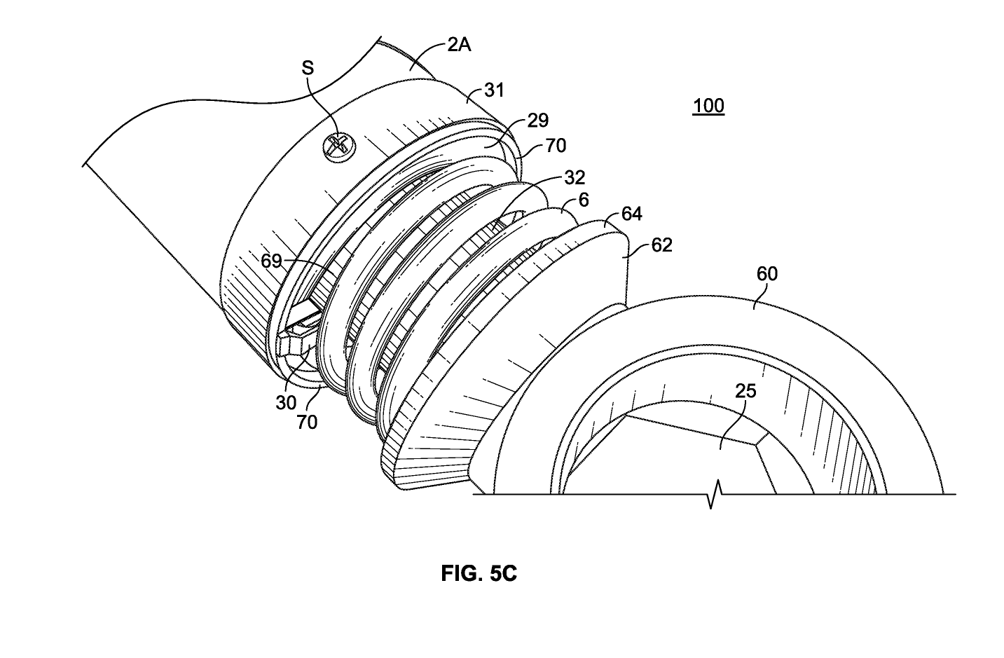

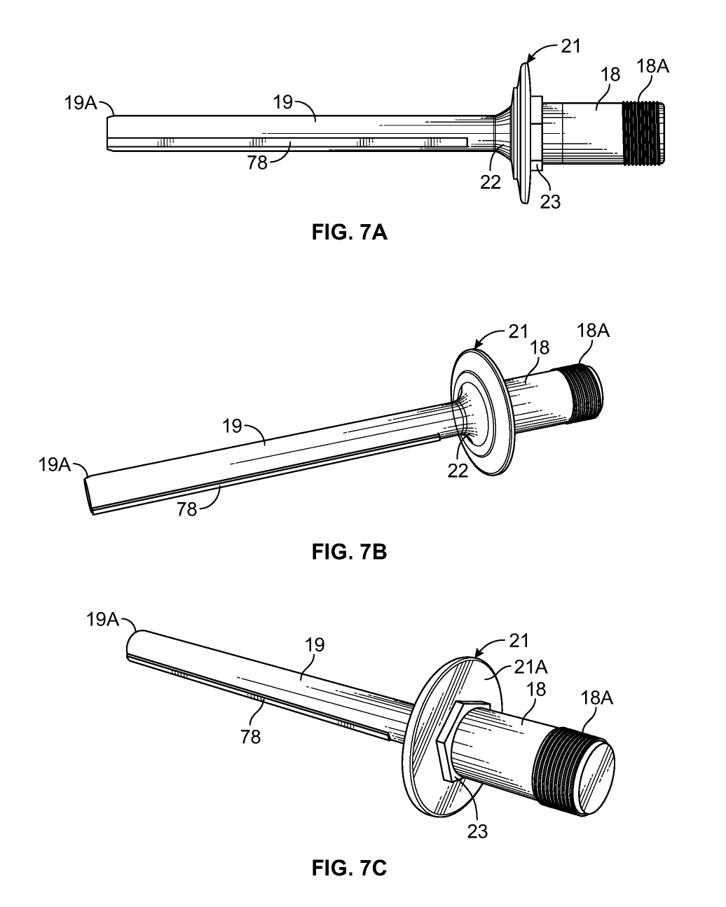

Referring to FIG. 5, a suspension assembly 100 of an embodiment generally comprises a suspension body portion 2, a suspension arm 3, a coil spring mechanism 6, and a brake actuator 7. Continuing with reference to the suspension assembly 100 of the embodiment of FIG. 5, the suspension arm 3 is further comprised of a mounting arm element 60 (for receipt and secure non-rotatable attachment of the spindle mounting stub 18, of which said mounting stub 18 comprises a first end of the spindle 9 (detailed below), a suspension arm spring/piston mount 62 and a suspension arm piston 32 for insertion into an internal cylindrical piston bore 33 of the suspension body 2. The mounting arm element 60 is further comprised of a mounting aperture 25 for non-rotatable receipt and attachment of the terminus end of the spindle mounting stub 18 (i.e., the first end of the spindle 9), a female alignment fitting 24 (for receipt and securing of a corresponding male support flange element 23, located on the spindle 9; see FIGS. 4, 7A and 7C). In an embodiment, the male support flange element 23 of the spindle 9 is of a corresponding shape and size to securely fit within the corresponding female alignment fitting 24 for non-rotatable attachment of the spindle 9. See FIGS. 4, 7A and 7C. The terminus end of the spindle mounting stub 18 extends through the mounting aperture 25 and is secured to the mounting arm element 60 by means of a mechanical mounting nut 77 whereby the inner threaded portion thereof is of a corresponding diameter and thread dimension for receipt, tightening and securing of the reciprocal threaded first end of the spindle 9 (the threaded terminus end of the spindle mounting stub 18).

Continuing with reference to the suspension assembly 100 of the embodiment of FIG. 5, the suspension body 2 is generally comprised of a tubular-shaped main suspension body portion, with an internal volume, further comprising a suspension body cylindrical piston bore 33, an external surface 2A, an alignment rod 28, a recessed spring retainer pan 29 and a spring retainer fitting 30. The recessed spring retainer pan 29 is further comprised of an inner perimeter wall 69 and an outer perimeter wall 70. The spring retainer pan 29 and the spring retainer fitting 30 provide for secure detachable attachment of the coil suspension spring 6 to the suspension body 2. The suspension assembly 100 is further comprised of a coil suspension spring 6 of sufficient size and strength for providing suspension of the carrier (hand truck) and the weight of the load transported—absolute and relative—that, upon sufficient compression as a result of gravity forces described further below, allows activation of the brake activator 7 vis-à-vis the braking hub assembly 200. The brake actuator 7 is further comprised of a brake actuator mount 31, a brake actuator calibration spring 35, a calibration spring mounting block 67 and a brake pad 68.

Continuing with FIG. 5, the suspension arm spring/piston mount 62 the suspension arm portion 3 is further comprised of an outer perimeter wall element 64 and a spring retainer fitting 65 for secure detachable attachment of the coil suspension spring 6 to the suspension arm 3. See also FIGS. 5B-C. When the suspension assembly is fully assembled, therefore, the suspension spring coil 6 is securely attached to both the upper suspension body portion 2 and the lower suspension arm portion 3, with the suspension arm piston 32 extending through the inner portion of the suspension spring coil 6.

When the various elements and features of the suspension assembly 100 of the embodiment of FIG. 5 are assembled in a functional configuration, the suspension spring coil 6 fits around the suspension arm piston 32, and is bounded on its upper end by the recessed spring retainer pan 29 of the suspension body 2 and bounded on its lower end by the flat surface of a recessed mount pan 63 of the suspension arm spring/piston mount 62. The recessed spring retainer pan 29 is essentially donut-shaped, bounded on its inner perimeter by an inner perimeter wall 69, bounded on its outer perimeter by the circumference of the internal wall portion 70 of the lower first end of the suspension body 2 and of relative shallow depth for holding the suspension spring coil 6 in place. The spring retainer pan 29 is of corresponding size to receive the spring suspension coil 6, hold it in place and prevent the coil spring from bending or denaturing in shape or integrity. The spring suspension coil 6 is securely fastened (detachable attachment) to the suspension body portion 2 via a spring retainer fitting 30. See also FIGS. 5A, 5C. Similarly, the recessed spring/piston mount pan 63 of the suspension arm spring/piston mount 62 is also essentially donut-shaped, its inner perimeter defined by the suspension arm piston 32, its outer perimeter defined by the internal circumference of the outer perimeter wall element 64 of the suspension arm spring/piston mount 62 and is slightly recessed and of relative shallow depth for holding the suspension spring coil 6 in place. The spring suspension coil 6 is securely fastened (detachable attachment) to the suspension arm portion 3 via a spring retainer fitting 65. See also FIG. 5B.

Continuing with FIG. 5, the suspension arm piston 32 of the suspension arm 3 extends through the inner coil of the coil spring suspension 6 and into the internal cylindrical piston bore 33, which is of sufficient size and diameter for easy receipt thereof, and allowing the piston to freely move back and forth within the internal suspension body piston bore 33, thereby providing wheel suspension assistance to the device and system. The alignment rod 28 of the suspension body 2 similarly extends into a corresponding internal piston alignment bore 66 of the piston 32 of the suspension arm 3, thereby providing a secure guide for aligning and attaching the suspension arm 3 to the suspension body 2. Importantly, in an embodiment, the suspension arm 3 should be fixed and not permitted to rotate with respect to the suspension body 2. The alignment rod 28 and its corresponding internal piston alignment bore 66 in the piston 32 are uniquely shaped (such as, for example, the cross section of the alignment rod 28 and the piston alignment bore 66 are “D” shaped) to prevent any such rotation. See FIG. 5A. In addition, the internal piston alignment bore 66 should be of sufficient cross-sectional size to facilitate easy receipt of the corresponding alignment rod 28.

Referring again to FIG. 5, the suspension assembly 100 is mounted to a carrier structure 8 (not shown) by means of a mounting plate 4. See also FIG. 2. In an assembled configuration, the resting position of the suspension arm piston 32 within the suspension body piston bore 33 is determined by the spring constant of the coil spring 6. During operation, the piston 32 of the suspension arm 3 slides freely within the internal cylindrical piston bore 33 of the suspension body 2, whereby the resting compression state of the coil spring 6 depends on the spring constant of the coil spring 6 and the apparent weight of the carrier device 8 plus any load resting thereon.

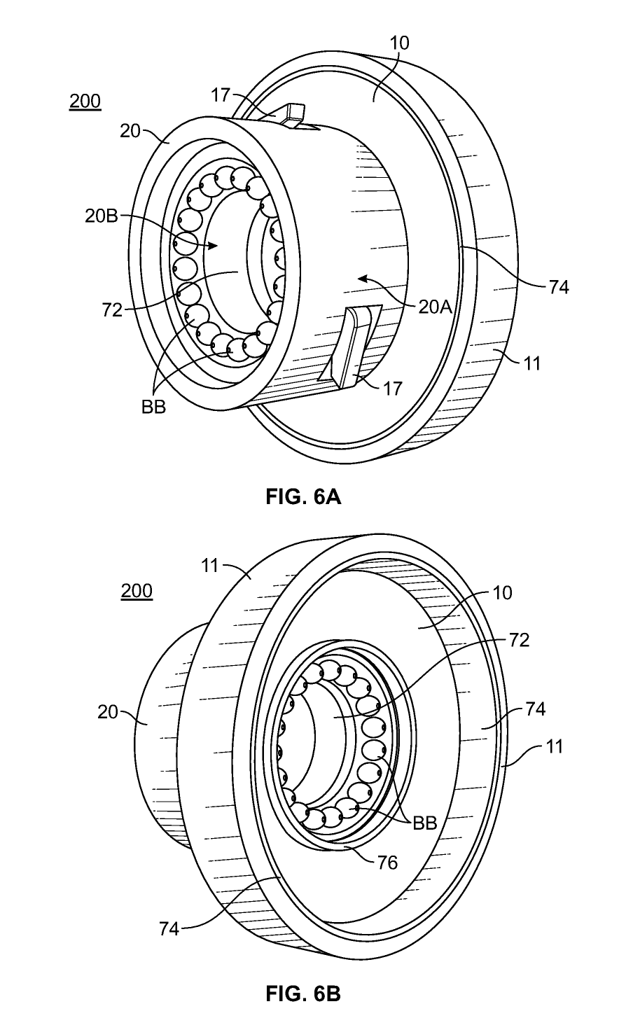

In the embodiment of FIG. 5, the brake actuator 7 is secured to the outer suspension body portion 2A. In an embodiment, the brake actuator 7 is attached thusly by means of a brake actuator mount 31 for detachable attachment. In the embodiment depicted in FIG. 5, the brake actuator mount 31 is comprised of a ring that securely fits over the external surface 2A of the suspension body 2 and is detachably attached thereto by threaded screws S that align with corresponding threaded apertures or screw holes (not shown in FIG. 5) for receipt, tightening and securing. While this is only one method of attaching the brake actuator 7 to the suspension body 2, other such means and methods are readily known to those skilled in the art and the described embodiment is not limiting or exhaustive. The brake actuator 7 is attached and configured in a non-rotatable fashion to the suspension body 2 such that, in use (as discussed with respect to FIGS. 6A-B), the brake pad 68 is fixed or located immediately above the brake band 11 secured to the outer rim portion 74 of the brake hub 10 of the braking hub assembly 200.

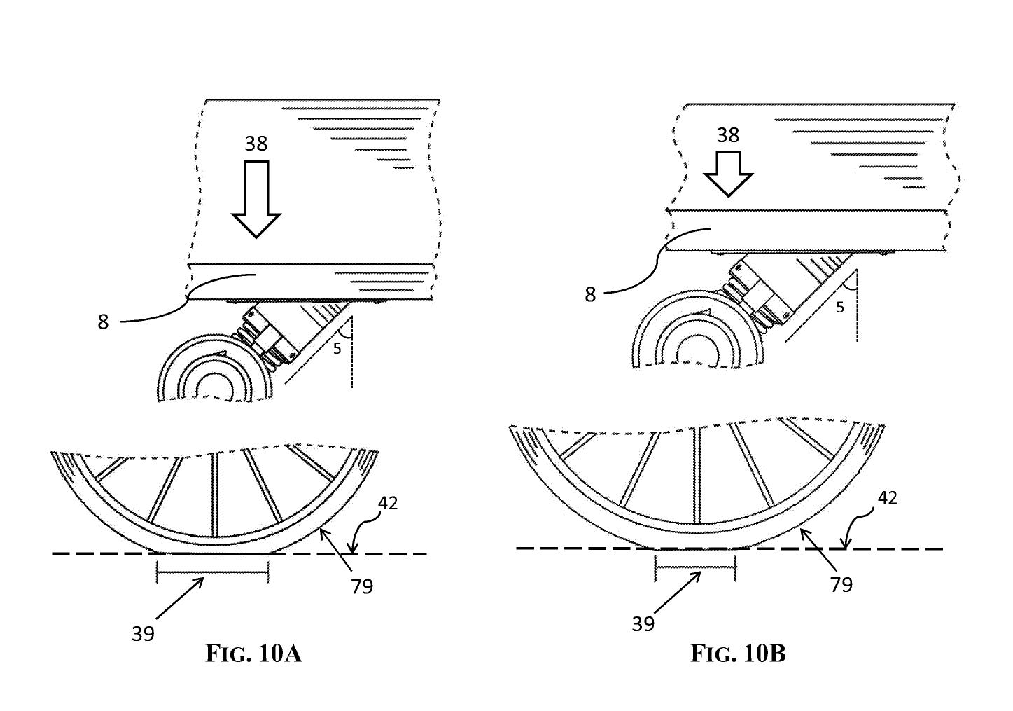

Continuing with the brake actuator 7, the calibration mechanism of that portion is comprised of a brake actuator calibration spring 35 secured on a first end within the brake actuator housing or calibration spring mounting block 67 and to which a second end brake pad 68 is securely attached. The calibration mechanism of the brake actuator 7 provides additional control over the braking force applied by brake pad 68 to the brake band 11 of the braking hub 10 (discussed as to FIGS. 6A-B) to ensure that the gravity-activated braking force does not exceed the static frictional forces between the contact surface of the wheel and the support surface, such as the ground floor or the horizontal surface or step of a stepped incline (see FIGS. 10A-C), thus ensuring that during operation the wheels describe a rolling motion rather than a sliding or slipping motion.

FIGS. 5A-C are various perspective views of portions of the suspension assembly 100 of the embodiment depicted in FIG. 5. FIG. 5A is a perspective view of the suspension body portion 3 (not attached to wherein the suspension arm 3) with a view into the internal piston bore 33. The coil suspension spring 6 is attached to the spring retainer pan 29 via the spring retainer fitting 30 holding the spring coil 6 securely in place. The alignment rod 28 extends from the terminal end (top) of the cylindrical piston bore 33 towards the bore aperture for receipt of the corresponding internal piston alignment bore 66 for secure non-rotatable receipt and alignment of the suspension arm piston 32. The spring suspension coil 6 is fastened tightly beneath the locking spring retainer fitting 30.

FIG. 5B is a perspective view of the suspension assembly 100 with an angled point of view from the suspension body portion 2 towards the suspension arm 3 with the mounting arm element 60 viewed from its top. The spring suspension coil 6 is tightly secured (detachably attached) to the suspension arm spring/piston mount 62 by its retainer fitting 65. The suspension arm piston 32, not in view, extends from the suspension arm spring/piston mount 62 through the inner portion of the spring suspension coil 6 (the coil 6 is wrapped around the piston 32). The terminal portion of the coil 6 rests within the recessed spring/piston mount pad 63 and is bounded on its outer perimeter portion by the suspension arm spring/piston mount outer perimeter wall 64 and is bounded on its inner perimeter by the suspension arm piston 32.

FIG. 5C is a perspective view of a portion of an assembled suspension assembly 100. The spring suspension coil 6 wraps around the suspension arm piston 32, a portion of which is depicted within its corresponding internal bore 33. The upper terminal end of the spring suspension coil 6 is tightly secured within the spring retainer fitting 30 of the suspension body 2. In this fully assembled depiction, the suspension assembly provides gravity-activated braking suspension to the device and system of the invention. Importantly, the alignment of internal piston alignment bore 66 of the piston 32 and the alignment rod 28 within the internal piston bore 33 allow the piston to freely slide within the bore of the suspension body while maintaining rotational alignment.

Turning now to the braking hub assembly 200, reference is made to an embodiment of the invention as depicted in FIGS. 6A-B. In an embodiment, the braking hub assembly 200 is comprised of a brake hub 10, comprising an outer rim portion 74 to which a brake band 11 is attached, affixed or applied thereto, and a braking hub body 20. The braking hub body 20 is further comprised of an exterior portion 20A comprising one or more recesses securing spring-loaded ratchet pawls 17 (springs not depicted, but commonly understood in the art), and an internal portion thereof 20B, which further comprises a brake hub spindle aperture 72 and an internal flange rim 76. The braking hub ratchet pawls 17 protrude for interaction with a plurality of internal ratchet teeth 16 on the interior of the ratchet extension 15 of the of the freewheel hub assembly 300. The braking hub assembly 200 is secured to the spindle 9 wherein the spindle rod 19 extends through the brake hub spindle aperture 72 and is secured thereto as described below. Further depicted are a plurality of ball bearings BB of size and dimensions necessary to properly function for their purpose when the brake hub assembly is mounted on the spindle 9, with additional hardware, features and elements 80, for attachment of the assembly with the suspension assembly 100.

The brake band 11 is generally comprised of a friction material. The brake hub assembly 200 is mounted on the spindle 9 such that the brake band 11 is in alignment with the brake pad 68 of the brake actuator 7 mounted on said suspension body 2. When gravity-activated braking forces are applied, the brake pad 68 comes into contact with brake band 11 of a freely moving brake hub assembly and, depending on the amount of frictional forces applied, rotation of the brake hub assembly is stopped via the braking action of the brake actuator 7.

FIGS. 7A-C are various perspective views of the spindle 9. The spindle 9 is generally comprised of a spindle mounting stub portion 18 and a spindle rod portion 19. The spindle mounting portion 18 is further comprised of a threaded end portion 18A (comprising a first end of the spindle 9) and a support flange 21, said support flange 21 being further comprised of a first flat surface side 21A and a second side comprised of a bearing cone 22. Immediately adjacent to the flat surface side 21A and comprising the spindle mounting stub portion 18 is a male fitting 23, for secure detachable attachment and alignment of the spindle 9 in the corresponding female alignment fitting 24 in suspension arm 3. The spindle rod portion 19 is further comprised of an end (comprising a second end of the spindle 9) and an elongated groove or slot 78 aligned with an axis of the spindle rod 19 and comprising a length of about or less than a portion of the rod 19.

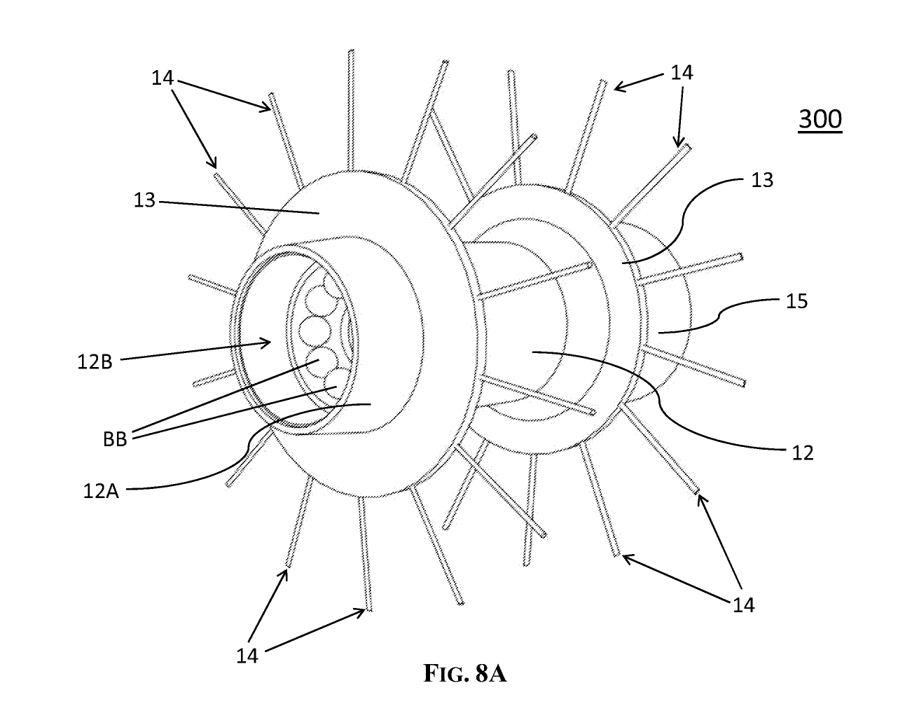

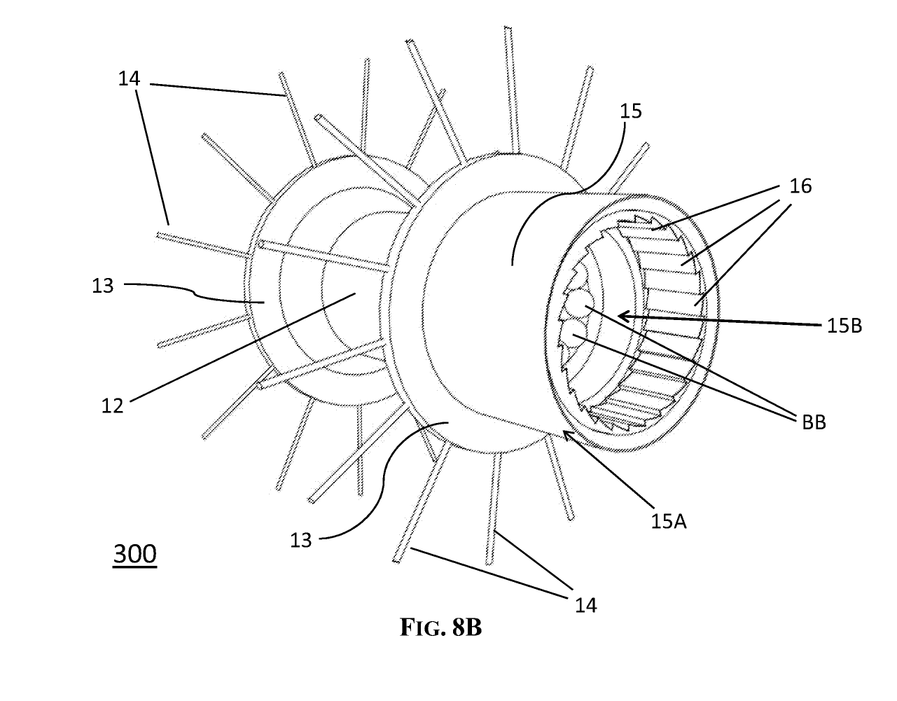

In an embodiment of the invention, the spindle 9 is non-rotatable and securely detachably attached to the suspension assembly 100 for purposes of providing a non-rotatable means of attachment and secure assembly of the brake hub assembly 200 and the freewheel assembly 300. The threaded end 18A of the spindle mounting hub passes through the mounting aperture 25 of the suspension arm 3. The spindle 9 is oriented such that the male fitting 23 aligns with and securely fits into its corresponding female support fitting 24. The male fitting 23 mates with the female alignment fitting 24 in the mounting eyelet 25 of the suspension arm 3 to prevent rotation of the spindle mounting stub 18 within the suspension arm 3, thus ensuring the proper alignment of brake band 11 and brake actuator 7. In addition, the spindle 9 is secured to the suspension assembly 100, and the brake hub assembly secured and aligned to the spindle 9, to ensure proper alignment of the brake actuator 7 of the suspension assembly with the brake band 11 of the brake hub assembly. The threaded end 18A of the spindle mounting hub is secured to the mounting arm element 60 by means of a mechanical mounting nut 77 or mounting nut 77 with flat washer 82 (or such other means readily known to those of skill in the art) whereby the inner threaded portion thereof is of a corresponding diameter and thread dimension for receipt, tightening and securing of the reciprocal threaded first end of the spindle 9 (the threaded terminus end of the spindle mounting stub 18). See FIGS. 4 and 8A.

In an embodiment, the brake hub assembly of FIGS. 6A-6B is mounted on the secured spindle 9. Referring to FIG. 3 (exploded view), the spindle rod 19 passes through the aperture 72 of the brake hub 10 and extends out from the open end of the internal portion 20B of the braking hub body 20 (the second end of the spindle 9 being distal to the brake hub-suspension assembly portion). The bearing cone side 22 of the support flange 21 is secured into and within the internal portion 20B of the braking hub body 20 (see FIG. 6B), wherein the ball bearings BB depicted in FIG. 6B are in contact with the bearing cone 22, thereby allowing the brake hub assembly to freely rotate about the axis of the spindle rod 19. The braking hub assembly 200 is securely mounted to the spindle 19 with additional ball bearings (see FIG. 6A), one or more slotted washers in which the slots or tabs thereof are affixed within the spindle rod groove/slot 78, and a coned nut for holding the ball bearings in place against an inner surface portion or ball bearing BB holding flange of the internal portion of the braking hub body 20B. See FIG. 3 for securing hardware.

As such, while securely attached to the spindle 9, the braking hub assembly freely rotates about the axis of the spindle rod 19, subject to gravity-activated braking by the brake actuator 7 of the suspension assembly 100.

The freewheel hub assembly 300 generally comprises a wheel and hub assembly and freely rotates about the axis of the spindle rod 19, independent of the braking hub assembly. The freewheel hub assembly comprises a central freewheel hub 12, one or more freewheel hub flanges 13 to accommodate spokes 14 for supporting a wheel rim and tire (not pictured), a freewheel hub extension 12A, and a ratchet extension hub 15. The ratchet extension hub 15 extends from a first freewheel hub flange 13 and is comprised of an outer body portion 15A and an internal portion 15B, the inner surface of which is comprised of a plurality of ratchet teeth 16 that are aligned along the axis of the hub 15. The freewheel hub extension 12A extends from a second freewheel hub flange 13. The freewheel hub 12, the freewheel a freewheel hub extension 12A, and a ratchet extension hub 15 a freewheel hub extension 12A, and a ratchet extension hub 15, and the ratchet extension hub 15 each comprise an inner portion in alignment for mounting on the spindle rod 19 of the spindle 9. The hub extension 12A is comprised of an aperture through which the spindle rod terminus 19A extends for receipt of terminal mounting hardware, namely ball bearings BB, a coned nut 81, a tabbed washer 26, a flat washer 82, dust cover 27 and mounting nut 77. See FIG. 4.

The freewheel hub assembly 300 is mounted on the spindle 19 such that the ratchet extension hub 15 fits over the braking hub body 20. Specifically, the internal portion 15A of the ratchet extension hub 15 fits over the exterior portion or surface 20A of the braking hub body 20 such that the braking hub body 20 is enclosed within the interior of the ratchet extension hub 15. The interior surface of said freewheel hub ratchet extension 15 is outfitted with ratchet teeth 16. The braking hub body 20 comprises recesses in which spring-loaded ratchet pawls 17 reside, whereby the tips of said pawls float over the ratchet teeth 16 of the ratchet hub extension 15 of the freewheel hub 12 when the freewheel hub rotates in a first direction (D1) and engages with said ratchet pawls 17 in the braking hub 10 when the freewheel hub is rotating in a second and opposite direction (D2). See FIG. 3 for directional movements D1 and D2. Consequently, the rotation described in D1 is a free-wheel action and the rotation described in D2 is restricted to the rotation described by the braking hub 10, which is in turn restricted by the braking force applied by the brake actuator 7 to the brake band 11, described in greater detail below.

The freewheel hub assembly 300 and the braking hub assembly 200 are rotatably attached to the spindle rod 19. Referring to FIG. 4, at least one set of ball bearings BB is provided for rotatably supporting the freewheel hub assembly 300 and at least one separate set of ball bearings is provided for rotatably supporting the braking hub assembly 200 on the spindle 9 such that, barring the influence of other mechanisms, such as, for example, activation of the braking mechanism of the brake actuator 7 to the braking hub assembly, said freewheel hub assembly 300 and said braking hub assembly 200 rotate about the spindle rod 19 independently of each other.

Referring to FIG. 4, and drawings of the various assemblies as necessary, a tabbed washer 26 is mounted between the a first bearing cone nut 81 extending into the inner portion 20B of the braking hub body 20, wherein a first set of ball bearings BB therein reduces the friction between the conical portion of the first cone nut 81 and an internal ball bearing holding flange (not numbered) in the inner portion 20B of the braking hub body 20 (see FIG. 6A) and a second bearing cone nut 81 extending into the internal portion 15B of the ratchet extension hub 15, wherein a second set of ball bearings BB thereby reduces the friction between the conical portion of the second cone nut 81 and an internal ball bearing holding flange (not numbered) in the inner portion 15B the ratchet extension hub 15. See FIG. 8B. The tabbed washer 27 comprises a tab element that locks into the slot/groove 78 of the spindle rod 19, thus allowing the first bearing cone nut 81 within the inner portion 20B of the braking hub body 20 to be tightened against the second bearing cone nut 81 within into the internal portion 15B of the ratchet extension hub 15, while securely fastening and aligning the braking hub assembly 200 on the spindle 9.

The freewheel hub assembly 300 is securely mounted on the spindle rod 19 by means of a third bearing cone nut 81 extending into an internal portion of the freewheel hub extension 12A, wherein a third set of ball bearings BB reduces the friction between the conical portion of the third cone nut 81 and an internal ball bearing holding flange (not numbered) in the internal portion 12B of the freewheel hub extension 12A. See FIG. 8A. The third bearing cone nut 81 is mounted to the terminal end 19A of the spindle rod 19 by means of a tabbed washer 26 and mounting nut 77, whereby the tabbed washer 26 locks in to the slot 78 in the spindle rod 19 and ensures that the bearing cone nut 81 maintains adjustment while the mounting locknut 77 is tightened. A spacer and dust cover 27 are mounted between the outer mounting locknut 77 and third bearing cone nut 81 to prevent dust and moisture from penetrating the inner portions freewheel hub assembly 300.

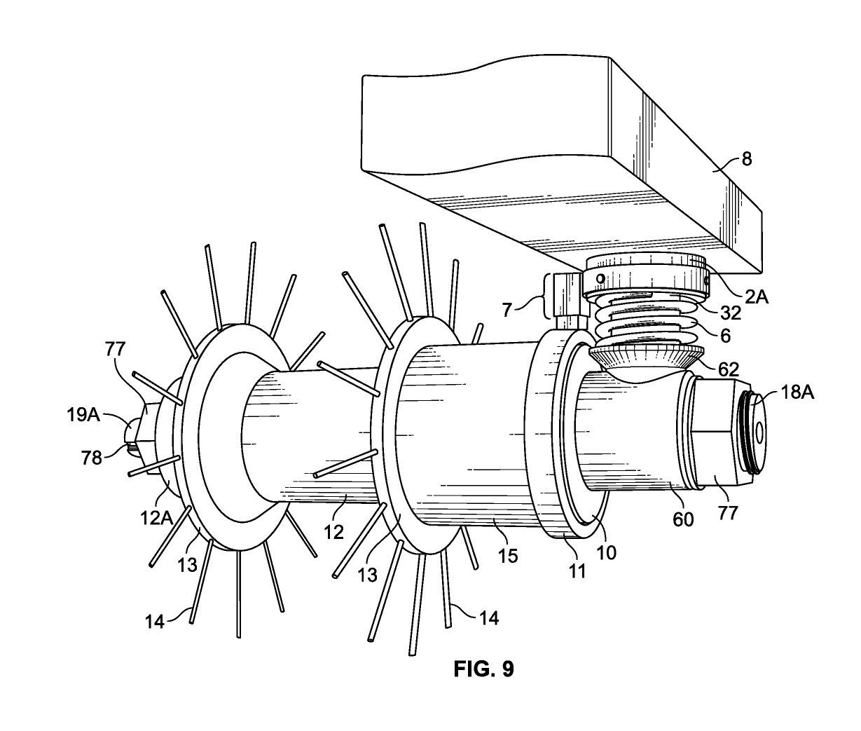

In an embodiment, the suspension assembly 100 is non-rotatably attached to a carrier structure 8 by means of a mounting plate 4 such that when the structure 8 is in a roughly horizontal orientation, the orientation angle 5 of the coil spring 6 is roughly 45 degrees from horizontal. See FIGS. 2-5. The carrier structure 8 is supported in relation to a supporting surface (e.g., the floor, ground or horizontal surface of a stepped incline) by a wheel rim and tire 79 which is attached to a freewheel hub 12 by means of spokes 14. See FIG. 2. In an embodiment, the suspension body 2 of the suspension assembly 100 is attached directly within a recessed volume or cavity of the carrier structure 8 without a mounting plate. See FIG. 9.

Referring to the braking hub assembly of embodiments depicted in FIGS. 3, 4, 6A, 6B and 9, a brake band 11 with friction material is affixed to the exterior of the outer rim portion 74 of the brake hub 10 such that said brake band 11 is in alignment with the brake actuator 7 mounted on said suspension assembly 100. In operation, the apparent weight 37 of the carrier structure 8 and any load resting thereon 38 compresses the coil spring 6 and causes the suspension arm piston 32 to retract within the suspension body piston bore 33. See FIG. 3, with load weight 38 being applied to the carrier 8. The amount of compression of the coil spring 6 is proportional to the apparent weight of the carrier structure 8 and the weight of any load 38 resting thereon. Correspondingly, the braking force applied by the brake actuator 7 to the brake band 11 mounted to the braking hub 10 increases proportionally to the compression state of the coil spring 6 and is therefore similarly proportional to the apparent weight of said carrier structure 8 and any load resting thereon, whereby said braking force remains constantly applied to the brake band 11 and is thus transferred to the braking hub assembly 200 independent of the rotational state of the freewheel hub assembly 300. The freewheel hub assembly 300, being rotationally independent of the braking hub assembly 200, is free to rotate in first direction D1, while in second direction D2, as previously indicated, the ratchet teeth 16 within the freewheel ratchet extension hub 15 engage with the ratchet pawls 17 on the braking hub body 20, thereby preventing rotation of the freewheel hub assembly 300. The braking force applied by the brake actuator 7 to the brake band 11 is thus transferred from the braking hub assembly 200 to the freewheel hub assembly 300 and consequently to the wheel 79 connected via the spokes 14 to the freewheel hub 12.

The orientation or angle of the spring coil 6 with respect to the force of gravity results in different compression coefficients. A spring coil 6 that is parallel to the force of gravity has a different compression coefficient than a spring coil 6 that is not parallel to the force of gravity. As such, since the invention is directed, among other uses, for use on stairs which are at an incline and not parallel with a level ground, in an embodiment of the invention, the spring coil 6 within the suspension assembly 100 is oriented at an angle, such that in operation, the compression coefficient is at or about maximum potential. This translates into a greater braking force, which is desired for use when transporting a heavy load up or down a flight of stairs. In an embodiment, therefore, the suspension assembly 100 is non-rotatably attached to a carrier structure 8 by means of a mounting plate 4, wherein the spring coil 6 is at an angle of orientation 5 (see FIGS. 10A-10C) such that when the structure 8 is angled upwards for operation in the ascent or descent of stairs, the suspension arm 3 and the thereto attached coil suspension spring 6 assume an orientation roughly parallel to the force of gravity, whereby that the maximum spring compression and hence the maximum braking force is achieved in said angled orientation rather than during operation on unstepped or non-inclined surfaces. See FIGS. 3-5; contrast with the embodiment of FIG. 9, which is not mounted at an angle.

As such, an increase in the absolute or apparent weight applied to the suspension assembly 100 activates the assembly's brake actuator 7, which applies a braking force to the braking hub assembly 200. As a result of the D1-D2 relationship of the ratchet pawls 17 of the braking hub assembly with the ratchet teeth 16 of the freewheel hub assembly 300, as described within, the braking force is further translated to the freewheel hub assembly 300, and thus, the wheel 79. In this manner, an increase in absolute or relative weight applied to the carrier 8 will brake the wheel(s) of the carrier that utilize the invention. As an increase in the gravitational forces applied to a gross carrier weight 36 (carrier weight 37 and cargo load weight 38 combined) supported by the invention is an increase in apparent weight, an increase said gravitational forces will also result in a braking of the wheel(s) of the system.

FIG. 10A shows the carrier 8 with a first load weight 38 corresponding to roughly 100% of the carrier's load capacity and a first contact surface 39 between the wheel's perimeter material (i.e., tire tread) 79 and the supporting surface 42 (i.e., the floor or stair tread), whereby the surface area of the first contact surface 39 is proportional to the first load weight 38 resting on the carrier frame 8. The coil spring 6 and brake actuator mechanism 7 are calibrated to apply a first braking force which inhibits the free rotation of the wheel 79 to a degree that significantly reduces the potential and/or kinetic energy of the system without exceeding the brake lock-up threshold above which the transition from rolling motion to skidding or sliding motion ensues.

FIG. 10B shows the carrier 8 with a second load weight 38 applied that corresponds to roughly 50% of the first weight, and a contact surface 39 between the wheel's perimeter material (i.e., tire tread) 79 and the supporting surface 42 (i.e., the floor or stair tread) whose surface area is reduced in proportion to the differential between the first load weight and the second load weight. The coil spring 6 and brake actuator mechanism 7 are calibrated to apply a second, reduced braking force which impedes the free rotation of the wheel to a lesser degree without exceeding the brake lock-up threshold above which the transition from rolling motion to skidding or sliding motion ensues.

FIG. 10C shows the carrier 8 with no weight applied and a contact surface 39 between the wheel's perimeter material (i.e., tire tread) 79 and the support surface 42 (i.e., the floor or stair tread) whose surface area is proportional to the weight of the unloaded carrier. The coil spring 6 and brake actuator mechanism 7 are calibrated to apply no braking force, resulting in unrestricted wheel rotation.

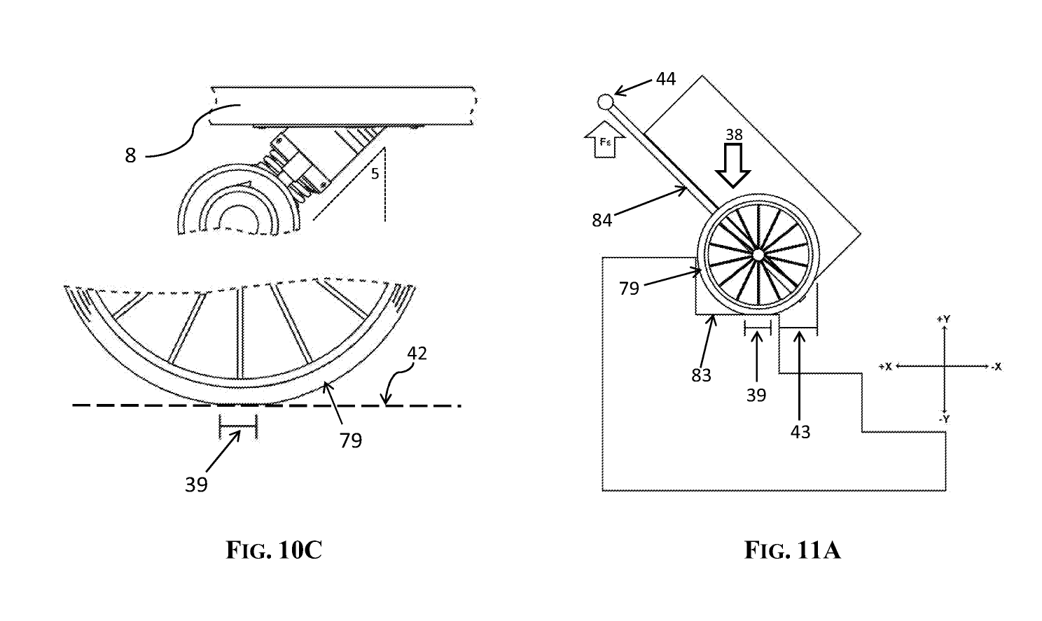

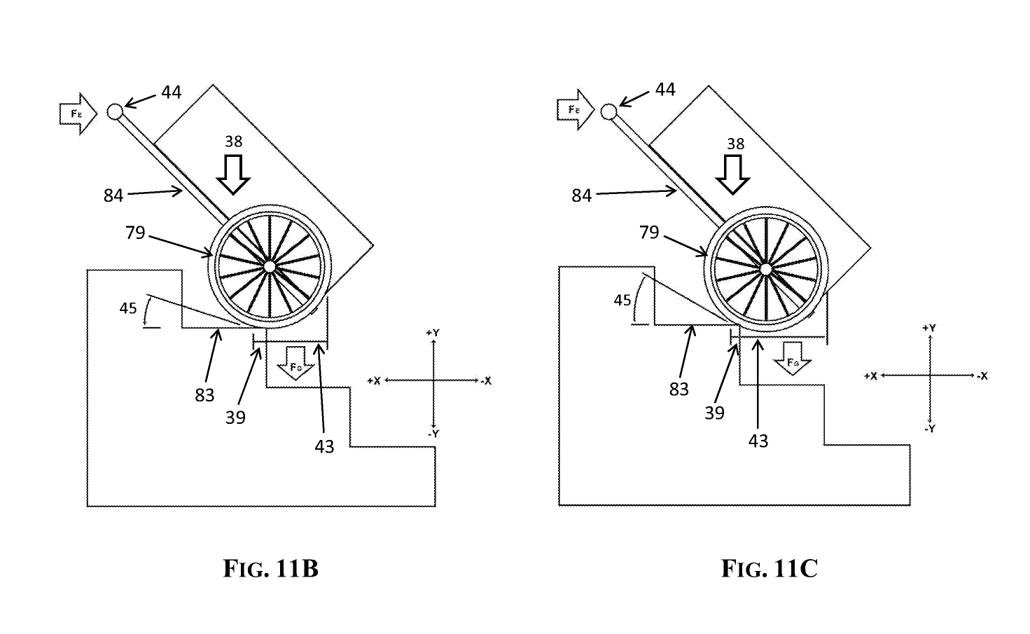

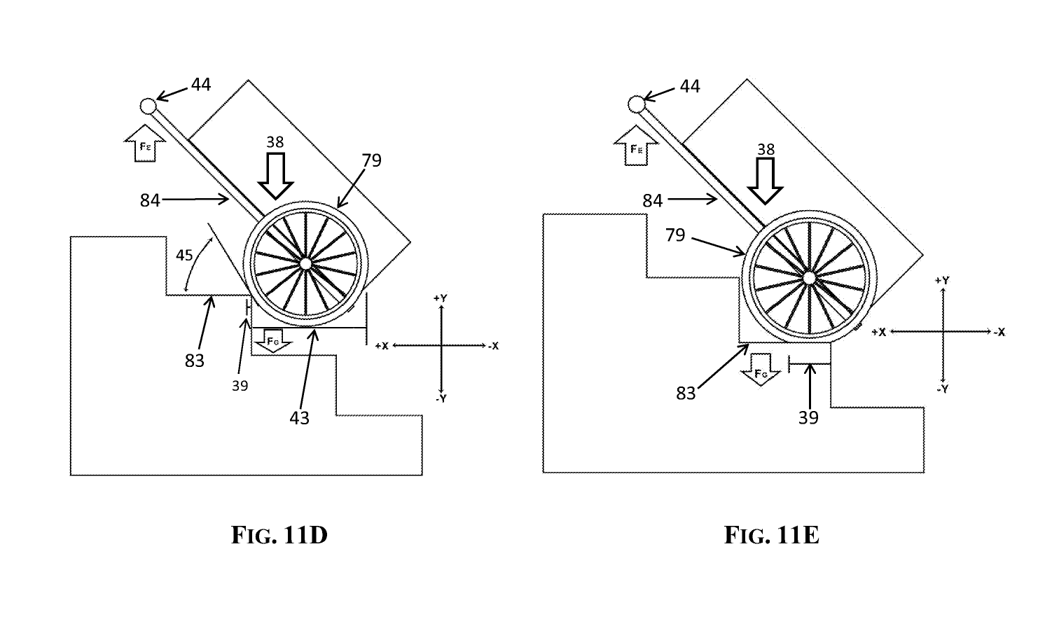

FIGS. 11A-11E are a series of side views of a carrier with an embodiment of the invention attached thereto transporting a weighted cargo on an illustrative set of stairs by descending a stair step thereon.

In FIG. 11A, the carrier stands at equilibrium on a stair tread 83, whereby a +Y-directional external force FE representing the action of a human operator is applied to the carrier handle 44 to maintain the carrier's angle of inclination. The contact surface 39 between the perimeter material (i.e., tire tread) of the wheel 79 is proportional to the load weight 38 resting on the carrier frame 84 and falls within the footprint of the stair tread 83. An overhang section 43 of the wheel extends in −X direction beyond the edge of the stair tread 83. A coil spring 6 and brake actuator mechanism 7 are calibrated (see FIGS. 10A-10C) to apply a braking force which inhibits the free rotation of the wheel to a degree that significantly reduces the potential and/or kinetic energy of the system without exceeding the brake lock-up threshold above which the wheel transitions from a rolling motion to skidding or sliding motion across the support surface.

In FIG. 11B, the operator exerts −X-directional force FE at the carrier handle 44 to move the carrier in −X direction, causing the wheel's axis to cross the Y plane of the edge of the stair tread 83. The wheel overhang 43 increases to over 50% of the wheel diameter and the carrier's gross weight is redistributed across the reduced contact surface 39. While in an unregulated system the carrier would be subject to gravity-induced acceleration in −X and −Y direction as soon as the wheel's axis crosses the Y plane of the edge of the stair, with the system described in this embodiment of the invention the wheel rotation, and consequently gravity-induced acceleration, is inhibited by the braking force applied by the brake actuator 7 for as long as significant static friction between the contact surface and the supporting surface is present.

In FIG. 11C, the contact surface 39 between the wheel and the stair tread 83 still provides sufficient static friction to maintain wheel rotation, but the force of gravitational acceleration exceeds the braking force. As a result, the wheel begins to rotate in −X/−Y direction around the point described by the edge of the stair tread 83 despite the continued braking force being applied by the brake actuator 7. The gravitational force now drives the carrier in −XY direction independent of the external force FE applied by the operator. As the wheel rotates further over the edge of the stair tread 83, the force of static friction between the decreasing contact surface 39 of the wheel and the edge of the stair tread 83 diminishes in proportion to the increasing angle 45 of the tangent described by the wheel's perimeter and edge of the stair.

In FIG. 11D, the angle 45 of the tangent described by the wheel's perimeter and edge of the stair has increased such that the force of gravitational acceleration exceeds the force of static friction. The wheel ceases rotation about its center axis and the carrier's state transitions from that of a rolling but rotationally-inhibited object to that of an uninhibited free-fall object that accumulates kinetic energy at an exponential rate in both −X and −Y direction until the free-fall event terminates.

In FIG. 11E, the carrier's wheels have collided with the next lower stair's supporting surface 42. The collision causes a temporary increase in the apparent weight of the carrier 8 as the kinetic energy accumulated during free-fall converts to force of impact. The carrier's apparent weight upon collision temporarily exceeds the gross weight 36 of the carrier 8 (carrier weight 37 and load weight 38), whereby the increase is proportional to the −Y distance traveled in free fall. Upon collision, the coil spring 6 temporarily compresses beyond the spring state calibrated for the current gross weight of the carrier, resulting in a corresponding spike in the braking force applied to the wheel's rotation, which in turn results in a corresponding decrease in the kinetic energy of the carrier 8 such that any residual momentum from the acceleration event can be more easily controlled by the operator. In effect, the gravitationally induced increase in the apparent weight activated the invention's braking system, thereby providing a braking force to the carrier wheel.

This description is neither intended nor should it be construed as being representative of the full extent and scope of the present invention.

This disclosure of the various embodiments of the invention, with accompanying drawings, is neither intended nor should it be construed as being representative of the full extent and scope of the present invention. The images in the drawings are simplified for illustrative purposes and are not necessarily depicted to scale. To facilitate understanding, identical reference terms are used, where possible, to designate substantially identical elements that are common to the figures, except that suffixes may be added, when appropriate, to differentiate such elements.

Although the invention herein has been described with reference to particular illustrative embodiments thereof, it is to be understood that these embodiments are merely illustrative of the principles and applications of the present invention. Therefore, numerous modifications may be made to the illustrative embodiments and other arrangements may be devised without departing from the spirit and scope of the present invention. It has been contemplated that features or steps of one embodiment may be incorporated in other embodiments of the invention without further recitation.

1. A weight activated wheel brake apparatus, comprising:
a suspension assembly, comprising a suspension body, a suspension coil spring comprising a first end and a second end, and a mounting arm for non-rotatable detachable attachment of a mounting spindle, wherein said first end of the suspension coil is securely attached to a first end of the suspension body and the second end of the suspension coil is securely attached to the mounting arm,
a brake hub assembly, comprising a brake hub and a brake hub body, wherein the brake hub body is further comprised of an inner portion for rotatable attachment to a mounting spindle and at least one recessed area on an outer surface thereof wherein said recessed area houses a ratchet pawl,
a free wheel assembly, comprising a free wheel hub connected to and in substantial alignment with a ratchet extension hub, wherein the free wheel assembly is further comprised of an inner portion for rotatable attachment to a mounting spindle and wherein an inner portion of the ratchet extension hub is comprised of a plurality of ratchet teeth for engagement with the at least one ratchet pawl of the brake hub assembly portion,
a brake actuator, comprising a brake pad and a mounting element thereof, and
a mounting spindle, comprising a first end and a second end,
wherein the first end of the mounting spindle is detachably attached to the mounting arm of the suspension assembly;
the brake hub assembly is mounted on the mounting spindle and freely rotates about it;
the free wheel assembly is mounted on the mounting spindle and freely rotates about it, wherein said free wheel assembly is further mounted thereon such that at least a portion of the outer surface of the brake hub body is enclosed within at least a portion of the inner portion of the ratchet extension hub whereby the at least one ratchet pawl of the brake hub assembly may engage the plurality of ratchet teeth in the inner portion of the ratchet extension hub; and
the brake actuator is mounted on the suspension assembly whereby the brake pad thereof is aligned with a surface of the brake hub.
